(19) United States
(12) Patent Application Publication
(10) Pub. No.: US 2018/0155087 A1
(43) Pub. Date: Jun. 7, 2018

(54) CARRYING DEVICE FOR MOBILITY AIDS

(71) Applicant: Susan Lapp, Snohomish, WA (US)

(72) Inventor: Susan Lapp, Snohomish, WA (US)

(21) Appl. No.: 15/370,813

(22) Filed: Dec. 6, 2016

(51) Int. Cl. B65D 33/14; B65D 33/02; A61H 3/00

(52) U.S. Cl. CPC B65D 33/14; A61H 2003/002; A61H 3/00; B65D 33/02

(57) ABSTRACT

A carrying device including substantially flexible walls and a substantially rigid base. The base may be made rigid via insertion of a rigid support between two substantially flexible base pieces coupled with at least one temporary joint, such as a zipper. The walls may include a plurality of pockets and open-bottom supports for items such as drinking glasses. The device may include straps with removable fastening mechanisms to allow the device to be disposed over, around, or between the handles of a mobility device, such as a walker or a wheelchair. The device may be comprised of washable or high-durability fabric.

### FIELD OF THE INVENTION

This invention relates generally to mobility devices, such as walkers, and, more specifically, to carrying devices configured to be coupled with mobility devices.

### BACKGROUND OF THE INVENTION

Persons in need of mobility aids, such as walkers and canes, are often unable to carry items such as mail, dishware and utensils, cups, writing materials, etc., because the individual's hands are required for using the mobility aid. To date, attempts to overcome this problem have introduced new problems, such as carrying trays that are rigid and impede the use of the mobility aid, bags that are too soft to securely hold things like food laden dishware, or that are otherwise cumbersome or difficult to use. These are just some of the problems this invention aims to overcome.

### SUMMARY OF THE INVENTION

This invention relates generally to mobility devices, such as walkers, and, more specifically, to carrying devices configured to be coupled with mobility devices.

The present invention consists essentially of four substantially soft walls coupled with a substantially rigid base. The four substantially soft walls may include a plurality of pockets and open-ended holders on the inside of the walls. The base may be comprised of two segments of substantially flexible fabric, wherein the two segments are permanently coupled at three seams, and wherein the fourth seam is removably coupled by zipper, hook-and-loop fastening, snaps, buttons, or other means of removably combining fabric pieces. The fabric may include particular material properties, such as being water-resistant, washable, stain proof, or it may include material elements such as grip areas comprised of high-friction material such as PVC foam. The base may be further comprised of an insertable plastic, cardboard, wooden, metallic, or other substantially rigid material, wherein the insertion of the rigid material causes the base to be rigid, and wherein removal causes the base to be substantially flexible.

The carrying device may further include a plurality of removable, flexible straps such that the device can be removably coupled with the mobility aid. In some embodiments, one strap may be permanently coupled to each end of the device, wherein the end of the strap has a first portion of a fastening mechanism, and wherein the second portion of the fastening mechanism is disposed on one of the inside or outside of the wall with which the strap is coupled. In other embodiments, the device may have a plurality of straps, each disposed at or near each of the four corners of the device. The fastening mechanisms may be any means for fastening two pieces of fabric, such as hook-and-loop, snaps, buttons, etc., but in preferred embodiments, the fastening mechanism will be hook-and-loop or snaps for ease of use for users with conditions such as arthritis.

In addition to the foregoing, various other methods, systems and/or program product embodiments are set forth and described in the teachings such as the text (e.g., claims, drawings and/or the detailed description) and/or drawings of the present disclosure.

The foregoing is a summary and thus contains, by necessity, simplifications, generalizations and omissions of detail; consequently, those skilled in the art will appreciate that the summary is illustrative only and is NOT intended to be in any way limiting. Other aspects, embodiments, features and advantages of the device and/or processes and/or other subject matter described herein will become apparent in the teachings set forth herein.

### BRIEF DESCRIPTION OF THE DRAWINGS

Certain embodiments of the present invention are described in detail below with reference to the following drawings:

FIG. 1 is an isometric environmental plan view of one embodiment of the carrying device;

FIG. 2 is an isometric plan view of the carrying device in an unfastened configuration;

FIG. 3 is a close up isometric view of the carrying device showing the openable base

FIG. 4A is an isometric view of one embodiment of the rigid base insert of the carrying device; and

FIG. 4B is an isometric view of an alternate embodiment of the rigid base insert.

### DETAILED DESCRIPTION

This invention relates generally to mobility devices, such as walkers, and, more specifically, to carrying devices configured to be coupled with mobility devices.

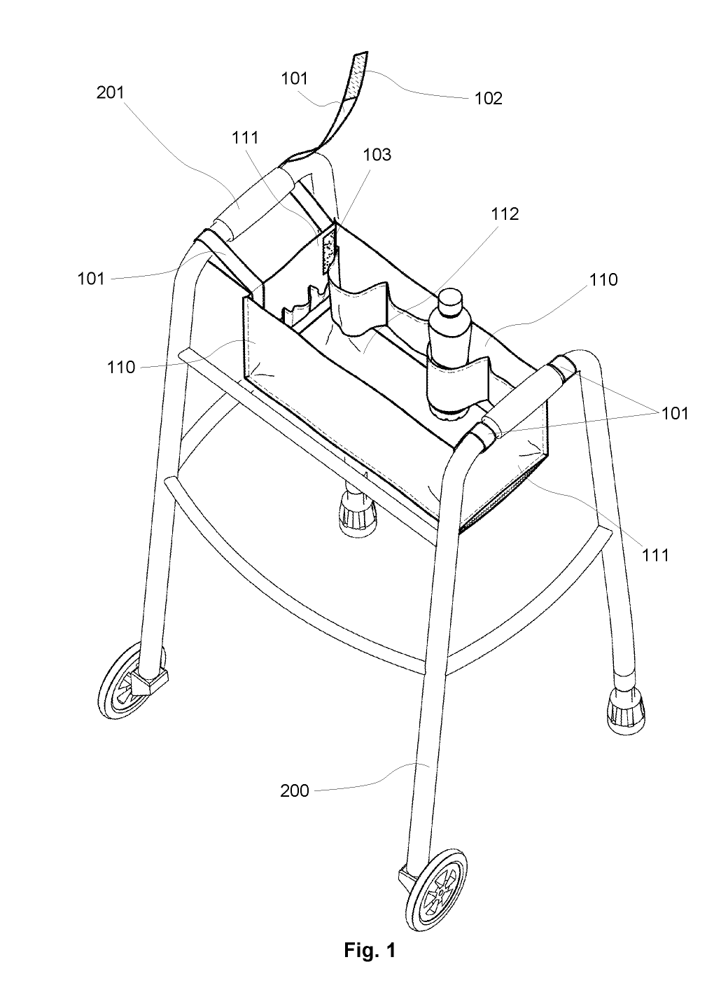

Specific details of certain embodiments of the invention are set forth in the following description and in FIGS. 1-4 to provide a thorough understanding of such embodiments. The present invention may have additional embodiments, may be practiced without one or more of the details described for any particular described embodiment, or may have any detail described for one particular embodiment practiced with any other detail described for another embodiment.

Importantly, a grouping of inventive aspects in any particular “embodiment” within this detailed description, and/or a grouping of limitations in the claims presented herein, is not intended to be a limiting disclosure of those particular aspects and/or limitations to that particular embodiment and/or claim. The inventive entity presenting this disclosure fully intends that any disclosed aspect of any embodiment in the detailed description and/or any claim limitation ever presented relative to the instant disclosure and/or any continuing application claiming priority from the instant application (e.g. continuation, continuation-in-part, and/or divisional applications) may be practiced with any other disclosed aspect of any embodiment in the detailed description and/or any claim limitation. Claimed combinations which draw from different embodiments and/or originally-presented claims are fully within the possession of the inventive entity at the time the instant disclosure is being filed. Any future claim comprising any combination of limitations, each such limitation being herein disclosed and therefore having support in the original claims or in the specification as originally filed (or that of any continuing application claiming priority from the instant application), is possessed by the inventive entity at present irrespective of whether such combination is described in the instant specification because all such combinations are viewed by the inventive entity as currently operable without undue experimentation given the disclosure herein and therefore that any such future claim would not represent new matter.

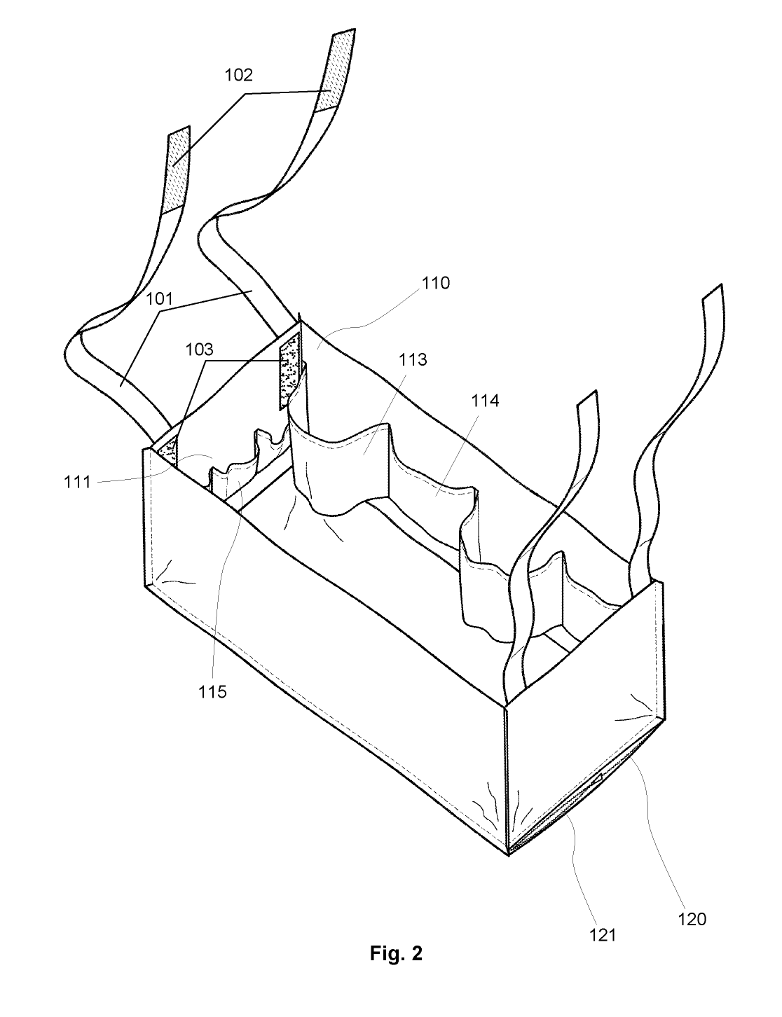

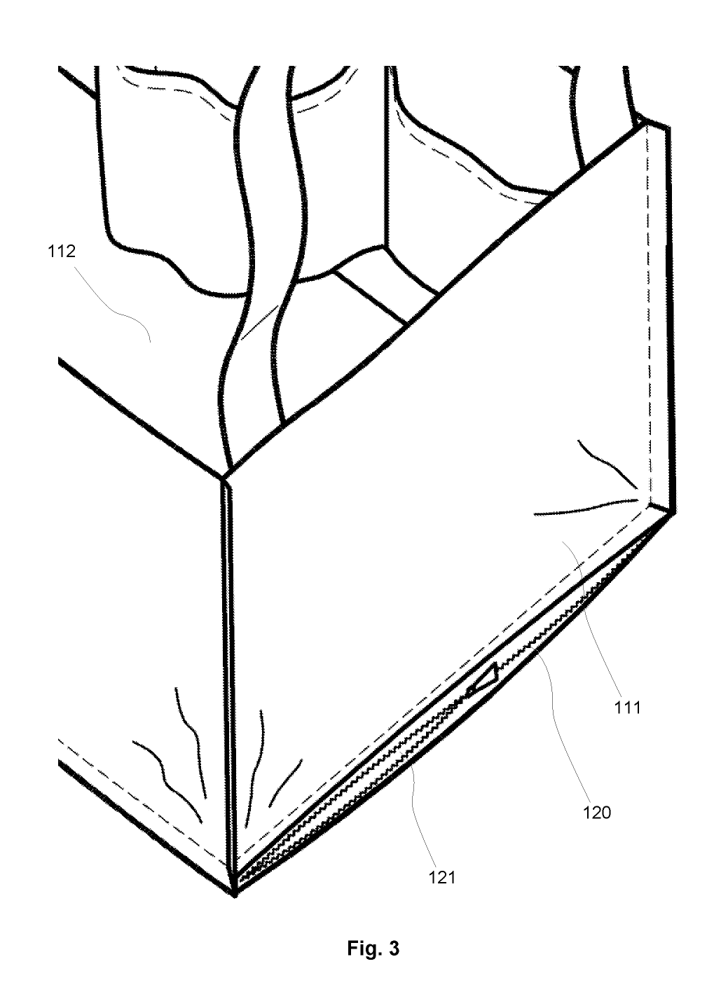

FIG. 1 is an isometric view of the carrying device disposed on a walker, the walker being a mobility aid and not comprising part of the current disclosure. The carrying device is comprised essentially of two long walls 110, two short walls 111, and one base 112. The walls and base will, in preferred embodiments, be comprised of a washable or water-resistant flexible material, such as denim, soft plastics, etc. The fabric may include particular material properties, such as being water-resistant, washable, stain proof, designed for high-durability, or it may include material elements such as grip areas comprised of high-friction material such as PVC foam. The base 112 may be comprised of a same or similar flexible material, or, in some embodiments, it may be comprised of a more rigid material, such as a more rigid fabric, a more rigid plastic, or even a hard plastic. In preferred embodiments, the walls and base will be comprised of materials that can be sewn, adhered, or welded together, forming a permanent open box configuration. The base will be discussed in additional detail with FIG. 2 and FIG. 3. In some embodiments, the carrying device may be elliptical, oval or circular in shape, rather than rectangular. In some embodiments, it may include a hinged lid, a removable lid, or some other means by which the contents can be covered.

The carrying device is, in some embodiments, coupled with the walker 200 via straps 101. In some embodiments, the carrying device may have only two straps 101, each disposed at the ends of the carrying device substantially in the middle of each of the short walls 111. In other embodiments, the carrying device may have four straps 101, each disposed on the short walls 111 approximately where they join with long walls 110. Straps 101 may include fasteners, wherein the first portion of the fastener 102 is disposed at or substantially near the distal end of the strap, as seen in FIG. 1. The second portion of the fastener 103 may be disposed on the proximal end of strap 101, or on the short wall 111 to which the strap is coupled. In some embodiments, the second fastener portion 103 may disposed on the inside of the wall 111 or proximal end of the strap. In other embodiments, the second fastener portion 103 may be disposed on the outside of the wall 111 or the proximal end of the strap. In either embodiment, the first fastener portions 102 will be disposed such that the loop can be formed by disposing the straps 101 around the handles of the walker 200 and coupling the first fastener portions with the second fastener portions 103. The fasteners may be any means for removably coupling fabric, such as snaps, buttons, and, in preferred embodiments, hook-and-loop fasteners (i.e. Velcro®).

FIG. 2 is an isometric view of the carrying device wherein the straps 101 are all in the open configuration, showing that first fastener portions 102 correspond to the location of second fastener portions 103 for coupling the device to the walker. Also shown are the pockets and holders disposed on both the long and short walls of the carrying device. One concern for users of mobility aids is being unable to carry items such as cups and glasses without spilling them. One embodiment of the present invention includes one or more holders 113, wherein both the top and the bottom are open, allowing a user to insert and securely carry items that must remain in an upright configuration. As shown, holders 113 are disposed on the long walls 110, but it should be understood that the holders may be disposed on the insides of walls 110 or 111, depending on a user's or manufacturer's preference. The device also may include one or more pockets 114, wherein the bottom is not open, allowing a user to carry smaller items, such as spice shakers, medication, or other items suited for small to medium sized pockets. The device may further include comparatively smaller diameter holders and pockets, as depicted by pockets 115 on short wall 111. These may be suited for carrying items such as pens, utensils, salt and pepper shakers, etc. The device will, in preferred embodiments, include a plurality of holders and pockets of both larger and smaller diameters, and may in fact include a plurality of pockets and holders with a plurality of diameters, in order to facilitate use of the device for diverse circumstances. It should be understood that the total number of pockets and holders, and the diameters thereof, may vary depending on the user and manufacturer, and these design choices will not substantially alter the function of the invention.

Also shown in FIG. 2 is base opening 120 and rigid form 121, and the position of the opening relative to the remainder of the device. The opening 120 is better depicted in the close up view of FIG. 3, which shows that, in some embodiments, the base 112 of the device may be comprised of two layers of the flexible material removably coupled on at least one side, forming opening 120. The opening 120 may be a permanent opening, or it may include a closing mechanism such as a zipper, a series of fasteners, or a length of hook-and-loop fastening material disposed along the inside of the opening for the length of the opening. In some embodiments, the device includes a rigid insert 121, which is configured to be inserted into the base via the opening 120 and to be substantially the same size and shape as the base. The rigid insert allows a user to temporarily form a rigid base 112 from the otherwise flexible base, allowing the user to carry items such as plates of food. When the user is no longer in need of a rigid base, or if the user wishes to launder the carrying device, the rigid insert 121 can be removed via opening 120, allowing the entire device to become flexible or substantially flexible once again. The rigid insert 121 may be comprised of any rigid or substantially rigid material, such as metal, wood, or rigid plastics. In preferred embodiments, the insert 121 is a rigid plastic, allowing a user to easily clean the insert if something is spilled within the carrier. While the opening 120 is depicted as being disposed proximate to a short wall 111, it should be understood that the opening may be disposed proximate to any of the walls. In preferred embodiments, the opening 120 may extend the length of one wall. In alternative embodiments, the opening 120 may extend the length of two or more walls, or it may be configured such that the entire lower fabric piece can be entirely removed from the upper fabric piece forming the base 112.

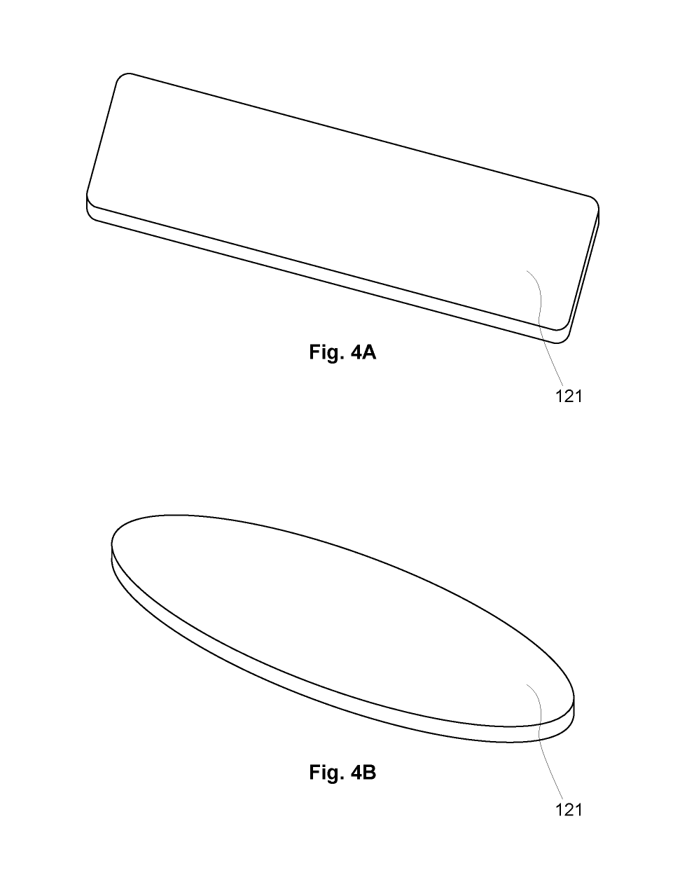

FIG. 4A is an isometric view of one embodiment of the insert 121. While the insert is shown here as substantially rectangular, it should be understood that it can be any shape, including oval, as in FIG. 4B. As depicted, insert 121 may show particular relative dimensions, but it should be understood that the particular dimensions of the insert will depend on the shape and intended use of the carrying device as a whole. Therefore, insert 121 may be thicker or thinner, narrower or wider, longer or shorter, as needed for the particular user. Some users may prefer a less rigid base, in which the insert 121 would be thinner. Some may prefer a very sturdy base, in which the insert 121 would be thicker. Some may prefer that the rigid base be in place even when a walker is in use, in which case insert 121 would be much narrower, allowing the carrying device to remain in place even while the walker is being used. As such, it should be understood that FIGS. 4A and 4B are exemplary with respect to dimensions.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

While preferred and alternative embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

1. A carrying device, comprising:
a base having two opposing longitudinal sides and two opposing transverse sides, the base further comprising at least:
an upper flexible portion;
a lower flexible portion, wherein the upper and lower flexible portions are removably coupled by a zipper mechanism on at least one side; and
at least one substantially rigid insert, wherein the substantially rigid insert is substantially the same shape as the base, and wherein the insert is configured to be removably inserted between the upper and lower flexible base portions and secured by the zipper mechanism;
two substantially flexible longitudinal walls, each one coupled with one longitudinal base side at a substantially right angle, at least one of the two substantially flexible longitudinal walls including at least one open-bottom holder;
two substantially flexible transverse walls, each one coupled with one transverse base side at a substantially right angle, such that the four walls and the base form an open-top container; and
at least two straps coupled with at least two walls on opposite sides.

2. The carrying device of claim 1, wherein the base is substantially rectangular in shape.

3-4. (canceled)

5. The carrying device of claim 1, wherein the at least two straps coupled with at least two walls on opposite sides comprise:
a proximate end permanently coupled with the carrying device; and
a distal end configured to be removably coupled with the proximate end.

6. The carrying device of claim 5, further comprising:
a first half of a removable fastening mechanism coupled with the proximate end; and
a complementary second half of a removable fastening mechanism coupled with the distal end.

7. The carrying device of claim 6, wherein the fastening mechanism is a hook-and-loop style fastener.

8. The carrying device of claim 6, wherein the fastening mechanism is a snap-style fastener.

9. A carrying device, comprising:
a base having two opposing longitudinal sides and two opposing transverse sides, the base further comprising at least:
an upper flexible portion;
a lower flexible portion, wherein the upper and lower flexible portions are removably coupled on at least one side; and
at least one substantially rigid insert, wherein the substantially rigid insert is substantially the same shape as the base, and wherein the insert is configured to be disposed between the upper and lower flexible base portions;
two substantially flexible longitudinal walls, each one coupled with one longitudinal base side at a substantially right angle, at least one of the two substantially flexible longitudinal walls including at least one open-bottom holder;
two substantially flexible transverse walls, each one coupled with one transverse base side at a substantially right angle, such that the four walls and the base form an open-top container; and
at least four straps, wherein each of the four straps are coupled with one wall.

10. The carrying device of claim 9, wherein the upper flexible portion and the lower flexible portions of the base are permanently coupled on at least one side.

11. The carrying device of claim 9, wherein the upper flexible portion and the lower flexible portions of the base are permanently coupled on three sides.

12. The carrying device of claim 9, wherein the two substantially flexible longitudinal walls comprise:
a plurality of pockets and holders permanently coupled with an inside portion of the flexible walls such that the opening of the pockets and holders is upward facing.

13. The carrying device of claim 9, wherein the two substantially flexible transverse walls comprise:
a plurality of pockets and holders permanently coupled with an inside portion of the flexible walls such that the opening of the pockets and holders is upward facing.

14. The carrying device of claim 1, wherein the two substantially flexible longitudinal walls comprise:
a plurality of pockets and holders permanently coupled with an inside portion of the flexible walls such that the opening of the pockets and holders is upward facing.

15. The carrying device of claim 1, wherein the two substantially flexible transverse walls comprise:
a plurality of pockets and holders permanently coupled with an inside portion of the flexible walls such that the opening of the pockets and holders is upward facing.
